(19) United States
(12) Patent Application Publication
(10) Pub. No.: US 2011/0200962 A1
(43) Pub. Date: Aug. 18, 2011

(54) Improved Dental Model Baseplate

(76) Inventor: Edwin T. Van Valey, Sudbury, MA (US)

(21) Appl. No.: 12/918,721

(22) PCT Filed: Feb. 17, 2009
(86) PCT No.: PCT/US09/00996

§ 371 Date: Nov. 22, 2010

Related U.S. Application Data
(60) Provisional application No. 61/066,554, filed on Feb. 21, 2008.

(51) Int. Cl. A61C 11/02; A61C 11/08

(52) U.S. Cl. 433/57; 433/213

(57) ABSTRACT

A dental model baseplate for use in the manufacture of a working dental model. The baseplate includes a connector element to fix a dental model articulator. An apparatus includes a plate portion and an adapter portion extending from the plate portion, the adapter portion configured for connecting to a portion of the dental articulator.

### RELATED APPLICATION

This application claims the benefit of U.S. Provisional Application No. 61/066,554, filed on Feb. 21, 2008. The entire teachings of the above application are incorporated herein by reference.

### BACKGROUND

In the fabrication of dental prosthetics, such as false teeth or crowns, a negative impression is made of the teeth of a dental patient using a pliable thermoplastic material. The negative impression is then filled with a hardenable material (commonly a modified gypsum) to form a positive representation of the patients teeth. On a working dental model, to allow improved access, the individual teeth that are to receive prosthesis are usually made so they are removable from the model and are referred to as a dies. Typically the model includes a base portion formed by making a separate pour of similar hardenable material and indexing means is employed between the pours (generally dowel pins) to releasably key the dies in the base of the model. It has become common to use a pre-manufactured base element to eliminate the need to create the base of the model by means of a second pour. There are several benefits to this scheme which accounts for the popularity of making dental models using this method. In some of these methods the base includes predefined holes for dowel pins and in other systems the holes are custom drilled in the plate or base to specifically correspond to the positions of the teeth. An example of the former system is disclosed in U.S. Pat. No. 4,708,835 by Wilhelm Kiefer of Germany wherein predefined holes are chosen and marked while the plate is indexed to the impression. These marked holes are then populated with dowel pins and then the indexing means is then used to place the plate and pins into the uncured die material.

The technique that involves drilling was first disclosed in the U.S. patent system in U.S. Pat. No. 4,371,339 by Manfred Zeiser of Germany and involves indexing the base to the negative impression of the natural teeth and using this indexed position to drill the holes into the base plate corresponding to positions of the teeth and again using the indexing to position the drilled plate (now with dowel pins placed into the drilled holes) above the impression so as to allow the incorporation of the heads of the dowel pins into the first pour of die material.

The original Zieser indexing method used a plate with slots on the sides which engage a rabbet portion on each side of the holding jig for the plate. This engagement mechanism allows the plate to slide into the indexed position. A further refinement of this model system is disclosed in German Patent No. DE4339746 which discloses an indexing mechanism comprising a dovetail element on the posterior wall of the plate which engages a slot on a carrier for the impression. This dovetail indexing mechanism is also used in a similar system sold by the AmannGirrbach Company also of Germany.

In order to complete the working model so the technician can create the prosthesis, the model needs to be articulated to the model of the opposing teeth. These systems both typically use a magnet fixed to the under surface of the model baseplate which then magnetically holds the model to the articulator. This involves placing a ferrous element on the magnet and embedding the attracted ferrous element in plaster (or vice versa) that is incorporated onto the upper or lower half of the articulator. This allows the model to be detached from the articulator for manipulation leaving the ferrous element on the articulator for reattachment of the model.

One drawback to articulating models made with baseplates of this type is the inability to reliably and precisely affix disposable or dispensable one-use articulators. These articulators are simply glued to the posterior walls of the models and their use has become extremely popular in dental laboratories today. One option to allow the use of glue-on articulators is to use an adaptor that is snapped onto the dovetail element such as what is offered by AmannGirrbach. Aside from the complexity and expense of entering an additional piece into the system this also adds instability between the baseplate and the articulator and a consequential loss of centric and vertical accuracy which detracts from the precision of the system as a whole.

### SUMMARY

Embodiments of the invention relate to working dental models as used in the fabrication of dental prosthetics. More particularly, embodiments of the invention may be used to provide a convenient method of articulating models that are made with model baseplates that have a dovetail type indexing element using one-use articulators.

An advantage of the present approach is that a model baseplate can easily allow the affixation of a one-use (e.g., glue-on type) articulator yet is compatible with known model systems.

The present approach allows for fewer and stronger connections of a glue-on type articulator to a model baseplate. In addition, the present approach provides a way to use a one-use articulator with a model baseplate system that affords greater centric and vertical accuracy.

In the discussion of existing model systems it was noted that there is not a convenient way to use the very popular one-use articulators on the models of this type. As of yet there has not been an effective way to use these articulators with these systems. This stems from the need for the baseplate to retain the ability to interlock with the carrier tray for the impression and also fit the holding fixture for drilling the baseplate. By molding an adapter to mate directly with an articulator integral with the baseplate and placing it in the same position as the dovetail, the adapter can be shaped in such a way that it can also function as the required indexing element. As the carriers are made from sheet metal and their mating elements for the dovetail consist of a slot that is sized to fit the neck of the dovetail, then these same dimensions can be used in forming a neck between a connection element for an articulator and the posterior wall of the baseplate. This allows a baseplate made in this fashion to directly accept a glue-on articulator and also correctly index to the impression carrier tray.

Embodiments of the improved baseplate fit a modified baseplate holder. The modification may include relieving material from the holder to allow the insertion of an improved baseplate. The relief being specifically for the portions that mate with the articulator, but being careful to preserve four surfaces that function with opposing surfaces of the dovetail and thusly providing accurate indexing of the baseplate in the holder. These surfaces are ones that face the posterior wall of the baseplate, the two surfaces that face the neck of the dovetail and the surface that faces the anterior or inside of the ‘T’ portion of the dovetail. By preserving these surfaces no loss of centric position for the inserted baseplate of either type is afforded.

Accordingly, in one aspect, an apparatus comprises a plate portion and an adapter portion extending from the plate portion, the adapter portion configured for connecting to a portion of a dental articulator. The adapter portion may be a connection element or a pair of spaced apart connection elements. The adapter portion may comprise a socket or a channel element.

In another aspect, an apparatus comprises a rectangular plate portion and an adapter portion extending from an end of the rectangular plate portion, the adapter portion configured for connecting to a portion of a dental articulator. The adapter portion may be an axial connection element or a pair of spaced apart connection elements. The adapter portion may comprise a socket or a channel element.

Another aspect features a baseplate for use with a dental model making system, the baseplate having a connection element to connect with an articulator. The connection element may include surfaces to cooperate with indexing elements of the dental model making system. The connection element may further include a portion to rotationally mate with an articulator. The connection element may allow the connected articulator to move about a single axis or about a set of orthogonal axes.

### BRIEF DESCRIPTION OF THE DRAWINGS

The foregoing will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a perspective view that shows a prior art baseplate having a single dovetail element on the posterior wall.

FIG. 2 is a perspective view that shows a prior art drilling fixture holding a prior art baseplate.

FIG. 3 is a perspective view that shows an impression mounted in a carrier tray which is above and indexed to a drilling fixture holding a baseplate.

FIG. 4 is a perspective view that shows a drilled baseplate fitted with dowel pins indexed in position above the impression.

FIG. 5 is a top perspective view that shows an embodiment improved with an element to connect a single-use articulator.

FIG. 6 is a top perspective view that shows the baseplate of FIG. 5 mounted in a holding fixture which has been modified to receive the connection element.

FIG. 7 is a perspective view that shows the baseplate of FIG. 5 drilled and populated with dowel pins re-indexed to the impression.

FIGS. 8 and 9 are perspective views that show a completed and articulated working model employing an alternate embodiment of a baseplate for use with half-arch or quadrant type models.

FIG. 10 is a perspective view that shows an embodiment of a baseplate improved with a multiaxial type connection element for an articulator.

### DETAILED DESCRIPTION

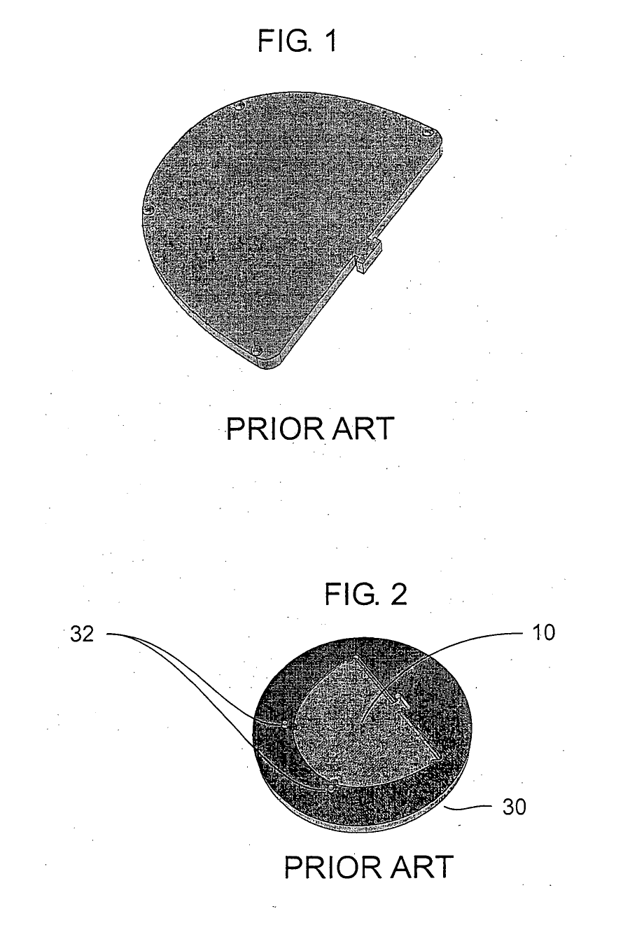

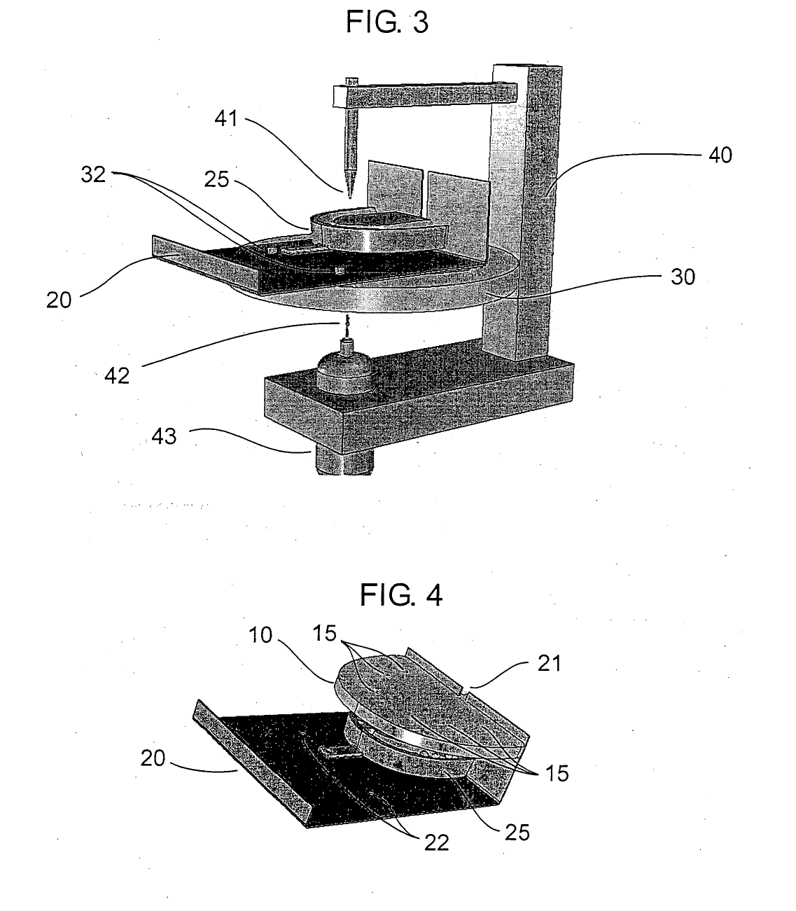

Reference is made to FIGS. 1 and 2 which show a prior art baseplate and holding fixture for the baseplate. In order to manufacture a working dental model using this technique the technician places a baseplate 10 into the holding fixture 30 which is centrically located by the precise fit of the dovetail on the posterior of the plate into a matching element in the fixture. A tray 25 containing an impression of the teeth to be restored and provided by the dentist is placed in a carrier 20 and held in place by a putty material. The carrier with this impression is shown above and indexed to the baseplate holder in FIG. 3. The carrier is held in precise position and indexed by means of indexing pins 32 of the holder which fit into holes 22 in the carrier. This position is such that the centric position of a dovetail element of a baseplate engaged in the slot 21 of the carrier is exactly the same as that of the corresponding element of the baseplate in the holding fixture. By holding these parts in this relationship it is then possible to transfer positions for dowel pins by using a reverse drill system 40 whose basic elements are also shown in FIG. 3. A prime factor of a drilling machine of this type is that pointer 41 is held exactly coaxial to drill bit 42. Thus a system of this type allows the technician to have a clear view into the impression and using a pointer such as 41 determine the exact desired position for a dowel pin in the completed model and by means of drill bit 42 and motor 43, drill a hole into the baseplate that is held in its holding fixture. It should be noted that for visual clarity the drilling apparatus shown in this drawing has no table which would be used to slide the assembly of impression/carrier and baseplate/holder to the proper position for drilling.

Once the holes are drilled, the baseplate is removed from the holder and the holes are then populated with dowel pins 15 such that knurled heads of the pins are left proud of the surface of the baseplate which is to contact the gypsum that will form the teeth. After the pins are inserted into the baseplate, it is then inverted so that the heads of the pins extend towards the impression and the dovetail element of the baseplate is inserted into the slot 21 of the carrier which reestablishes the centric position of the baseplate to the impression as shown in FIG. 4. The baseplate is then guided by the slot and moved so as to embed the heads of the pins into uncured material which has been flowed into the tray/impression which is still mounted in the carrier. When the gypsum material has cured to form a positive representation or model of the teeth it is then separated from the negative impression. From this model the individual tooth dies are now sectioned and by means of the dowel pins and their corresponding holes in the baseplate they can be reassembled on the baseplate in exact relationship.

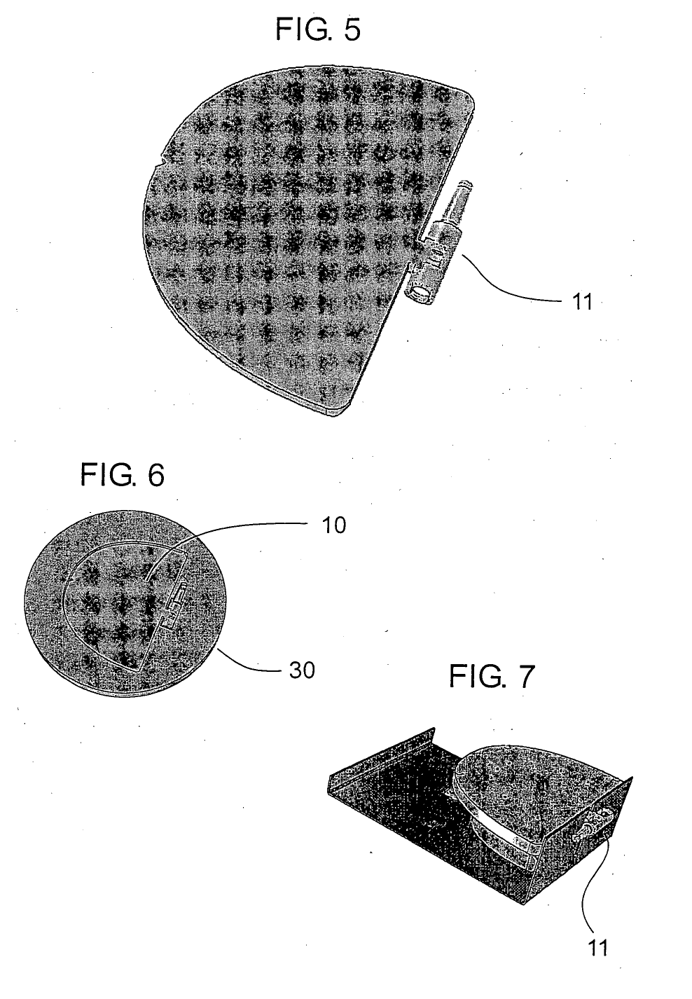

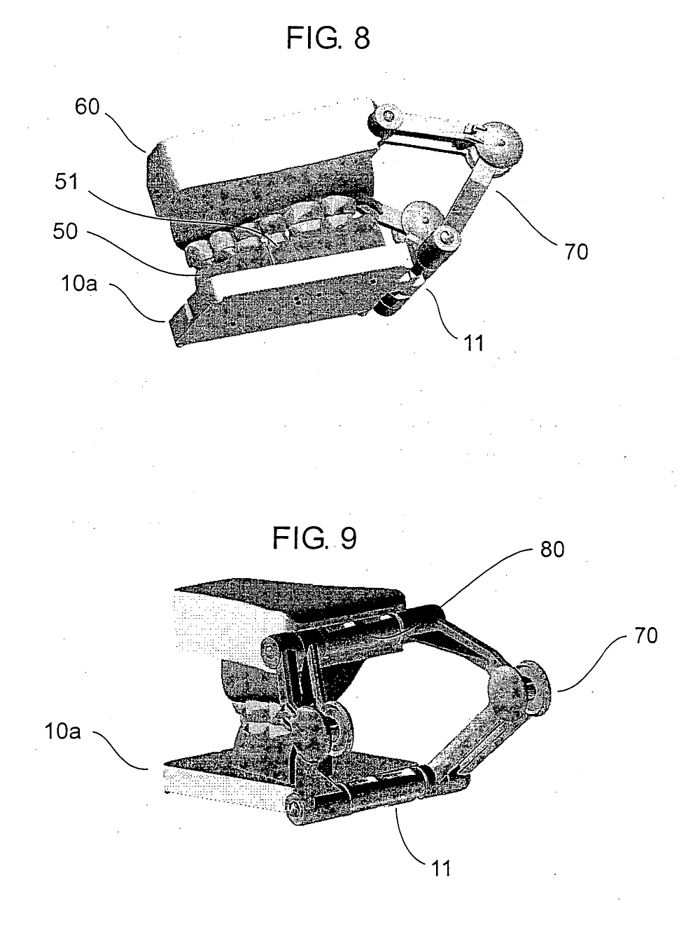

Referring to FIG. 5 an embodiment of the present invention is shown with an element 11 to accept the connection of an articulator. This connection element has a shape generally of the shape disclosed in U.S. Patent Application Publication No. 2006/0234181 (U.S. application Ser. No. 11/278,614), incorporated herein by reference. This application discloses a spacer 80 as shown in FIG. 9.

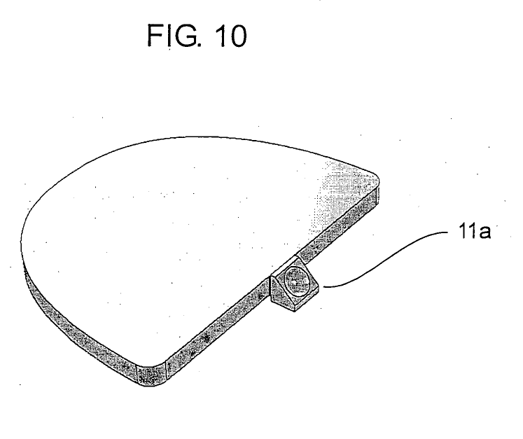

FIG. 6 shows a holder which can accept a baseplate as shown in FIG. 5. FIG. 7 shows the improved baseplate indexed onto a standard carrier. FIGS. 8 and 9 show a completed working dental model articulated with articulator 70 mated to element 11 of baseplate 10a. It should be noted these figures show an embodiment of the invention made specifically for half-arch or quadrant models. FIG. 8 shows an opposing model 60 made by prior art means and shows the working model 50 with a single removable die 51. FIG. 10 shows an embodiment of a baseplate improved with a multiaxial type connection element 11a for an articulator.

In some embodiments, the baseplate may include a pair of spaced apart connection elements. In other embodiments, the baseplate may incorporate a channel element which is integrally molded or attached to the baseplate.

While this invention has been particularly shown and described with references to example embodiments thereof, it will be understood by those skilled in the art that various changes in form and details may be made therein without departing from the scope of the invention encompassed by the appended claims.

What is claimed is:

1. Apparatus comprising:
a plate portion;
an adapter portion extending from the plate portion, the adapter portion configured for connecting to a portion of a dental articulator.

2. The apparatus of claim 1 wherein the adapter portion comprises a connection element.

3. The apparatus of claim 1 wherein the adapter portion comprises a pair of spaced apart connection elements.

4. The apparatus of claim 1 wherein the adapter portion comprises a socket.

5. The apparatus of claim 1 wherein the adapter portion comprises a channel element.

6. Apparatus comprising:
a rectangular plate portion;
an adapter portion extending from an end of the rectangular plate portion, the adapter portion configured for connecting to a portion of a dental articulator.

7. The apparatus of claim 6 wherein the adapter portion comprises an axial connection element.

8. The apparatus of claim 6 wherein the adapter portion comprises a pair of spaced apart connection elements.

9. The apparatus of claim 6 wherein the adapter portion comprises a socket.

10. The apparatus of claim 6 wherein the adapter portion comprises a channel element.

11. A baseplate for use with a dental model making system, the baseplate having a connection element to connect with an articulator.

12. The baseplate of claim 11 wherein the connection element includes surfaces to cooperate with indexing elements of the dental model making system.

13. The baseplate of claim 12 wherein the connection element includes a portion to rotationally mate with an articulator.

14. The baseplate of claim 13 wherein the connection element allows the connected articulator to move about a single axis.

15. The baseplate of claim 13 wherein the connection element allows the connected articulator to move about a set of orthogonal axes.
